(19) United States
(12) Patent Application Publication
(10) Pub. No.: US 2026/0105737 A1
(43) Pub. Date: Apr. 16, 2026

(54) METHOD AND DEVICE FOR GENERATING FACIAL IMAGES

(71) Applicant: Wistron Corp., New Taipei City (TW)

(72) Inventors: Chen Hsien WU, New Taipei City (TW); Kuo Chung CHU, New Taipei City (TW)

(21) Appl. No.: 19/002,053

(22) Filed: Dec. 26, 2024

(30) Foreign Application Priority Data
Oct. 16, 2024 (TW) 113139253

(51) Int. Cl. G06V 10/82; G06T 11/00; G06V 10/74; G06V 40/16

(52) U.S. Cl. CPC G06V 10/82; G06T 11/00; G06V 10/761; G06V 40/16

(57) ABSTRACT

A method for generating facial images is provided. The method includes generating a facial image by a generator of a generative adversarial network (GAN). The method includes determining whether the facial image is a real facial image by a discriminator of the GAN. The method includes inferring a similarity score for the facial image by at least one similarity determination model when the discriminator determines that the facial image is the real facial image. The method includes determining that the facial image is the real facial image and outputting the facial image when the similarity score exceeds a threshold.

### CROSS REFERENCE TO RELATED APPLICATIONS

This Application claims priority of Taiwan Patent Application No. 113139253, filed on Oct. 16, 2024, the entirety of which is incorporated by reference herein.

### BACKGROUND OF THE APPLICATION

### Field of the Application

The present disclosure generally relates to the field of image processing technologies. More specifically, aspects of the present disclosure relate to a method and a device for generating facial images using generative adversarial networks and neural networks.

### Description of the Related Art

Among the existing correction techniques for faces in photos, most correction techniques are based on selecting better photos from consecutive photos or using existing general facial databases as samples for artificial intelligence-generated images. However, after users modify the photos using artificial intelligence, they may still be inconsistent with the facial composite photos generated by artificial intelligence. In other words, the photos generated by artificial intelligence do not resemble real faces.

Therefore, there is a need for a method and device for generating facial images so that the generated facial photos (composite photos) are closer to real faces and achieve the purpose of providing more natural facial images.

### SUMMARY

The following summary is illustrative only and is not intended to be limiting in any way. That is, the following summary is provided to introduce concepts, highlights, benefits and advantages of the novel and non-obvious techniques described herein. Select, not all, implementations are described further in the detailed description below. Thus, the following summary is not intended to identify essential features of the claimed subject matter, nor is it intended for use in determining the scope of the claimed subject matter.

Therefore, a method and a device for generating facial images are provided in the present disclosure, so that the generated facial photos (composite photos) are closer to real faces and achieve the purpose of providing more natural facial images.

In an exemplary embodiment, a method for generating facial images is provided. The method includes generating a facial image by a generator of a generative adversarial network (GAN). The method includes determining whether the facial image is a real facial image by a discriminator of the GAN. The method includes inferring a similarity score for the facial image by at least one similarity determination model when the discriminator determines that the facial image is the real facial image. The method includes determining that the facial image is the real facial image and outputting the facial image when the similarity score exceeds a threshold.

In some embodiments, the method further comprises the following step: generating a loss value and feeding back the loss value to the discriminator and the generator by the discriminator when the discriminator determines that the facial image is not the real facial image.

In some embodiments, the method further comprises the following step: marking the facial image as a false facial image by the similarity determination model, and feeding the false facial image back to the discriminator when the similarity score does not exceed the threshold.

In some embodiments, before the generator generates the facial image, the method further comprises receiving a plurality of images of a person captured by a photographic device. The method further comprises the following step: obtaining the facial part in the plurality of images as samples of a plurality of real facial images by a processor.

In some embodiments, the method further comprises adjusting the threshold when the similarity score does not exceed the threshold and a condition is met. The condition is one of the following: the similarity scores inferred by the similarity determination model within a preset time period do not exceed the threshold and are within a preset range; and a number of times the similarity determination model has inferred the similarity scores have exceeded a preset number.

In some embodiments, when a number of similarity determination models is more than three and an odd number, the method further comprises outputting the facial image when more than half of the similarity determination models determine that the facial image is the real facial image. The method further comprises marking the facial image as a false facial image and feeding the false facial image back to the discriminator when more than half of the similarity determination models determine that the facial image is not the real facial image.

In some embodiments, the similarity determination model is based on a convolutional neural network (CNN) model, and the similarity score is a probability value.

In some embodiments, the similarity determination model is based on a Siamese neural network model, and the similarity score is a cosine similarity or a Euclidean distance.

In some embodiments, the similarity determination model is based on a Facenet model, and the similarity score is a probability value.

In some embodiments, the GAN and the similarity determination model are executed by a graphics processing unit (GPU).

In an exemplary embodiment, a device for generating facial images is provided. The device comprises one or more processors and one or more computer storage media for storing one or more computer-readable instructions. The processor is configured to drive the computer storage media to execute the following tasks. The following tasks comprise generating a facial image by a generator of a generative adversarial network (GAN). The following tasks determining whether the facial image is a real facial image by a discriminator of the GAN. The following tasks comprise inferring a similarity score for the facial image by at least one similarity determination model when the discriminator determines that the facial image is the real facial image. The following tasks comprise determining that the facial image is the real facial image and outputting the facial image when the similarity score exceeds a threshold.

### BRIEF DESCRIPTION OF DRAWINGS

The accompanying drawings are included to provide a further understanding of the present disclosure, and are incorporated in and constitute a part of the present disclosure. The drawings illustrate implementations of the disclosure and, together with the description, serve to explain the principles of the disclosure. It should be appreciated that the drawings are not necessarily to scale as some components may be shown out of proportion to their size in actual implementation in order to clearly illustrate the concept of the present disclosure.

FIG. 1 is an exemplary schematic diagram showing a system for generating facial images according to an embodiment of the present disclosure.

FIG. 2 is a schematic diagram showing a method of generating facial images according to an embodiment of the present disclosure.

FIG. 3 is a schematic diagram illustrating a face detection process according to an embodiment of the present disclosure.

FIG. 4 is a schematic diagram illustrating a face recognition process according to an embodiment of the present disclosure.

FIG. 5 shows a schematic diagram of the facial feature points according to an embodiment of the present disclosure.

FIG. 6 is a flowchart for inferring a similarity score for a facial image using a convolutional neural network model according to an embodiment of the present disclosure.

FIG. 7 is a flowchart illustrating a method for generating facial images according to an embodiment of the present disclosure.

FIG. 8 illustrates an exemplary operating environment for implementing embodiments of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using number of the aspects set forth herein. In addition, the scope of the disclosure is intended to cover such an apparatus or method which is practiced using another structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects. Furthermore, like numerals refer to like elements throughout the several views, and the articles “a” and “the” includes plural references, unless otherwise specified in the description.

It should be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion. (e.g., “between” versus “directly between”, “adjacent” versus “directly adjacent”, etc.).

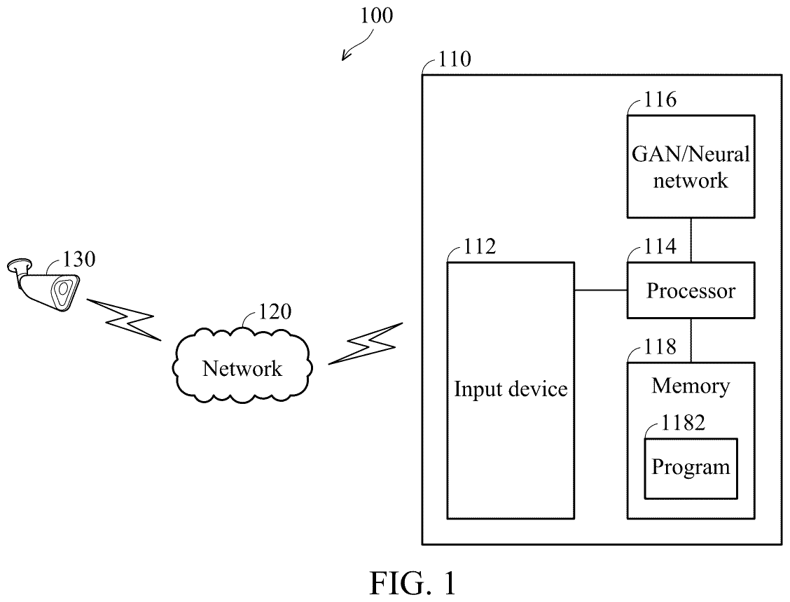

FIG. 1 is an exemplary schematic diagram showing a system 100 for generating facial images according to an embodiment of the present disclosure. The system 100 for generating facial images may comprise an electronic device 110 and a photography device 130 connected to the network 120.

The electronic device 110 may comprise an input device 112, wherein the input device 112 is configured to receive input data from various sources. For example, the electronic device 110 may receive facial image data from the network 120 or receive facial images transmitted by the photography device 130.

The electronic device 110 also comprises a processor 114, a generative adversarial network (GAN)/neural network 116, and a memory 118 that may store a program 1182. In addition, the images may be stored in the memory 118 or in the GAN/neural network 116. In one embodiment, the GAN/neural network 116 may be implemented by the processor 114, wherein the processor 114 may be a graphics processing unit (GPU). In another embodiment, the electronic device 110 may be used with components, systems, sub-systems, and/or devices other than those that are depicted herein.

The types of electronic device 110 range from small handheld devices, such as mobile telephones, to large mainframe systems, such as mainframe computers. Examples of handheld computers include personal digital assistants (PDAs) and notebooks. The photography device 130 may be connected to the electronic device 110 using the network 120. The network 120 may comprise, but is not limited to, one or more Local Area Networks (LANs) and/or Wide Area Networks (WANs).

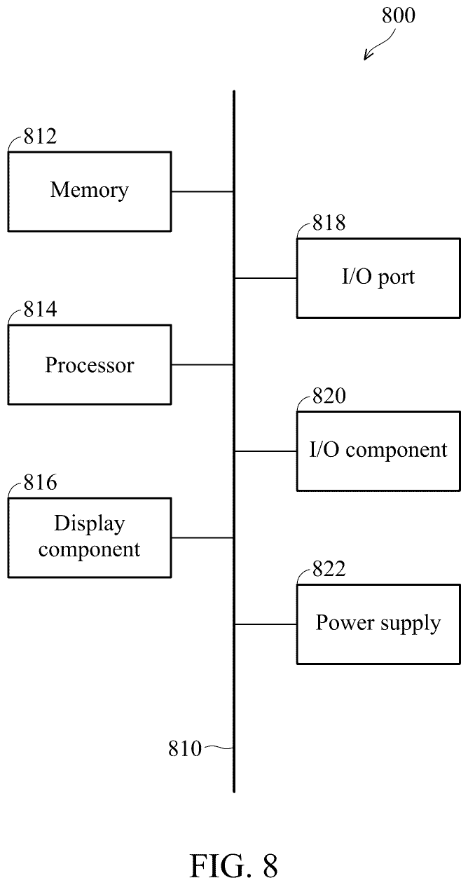

It should be understood that the electronic device 110 shown in FIG. 1 is an example of one suitable system 100 architecture generating facial images. Each of the components shown in FIG. 1 may be implemented via any type of computing device, such as the computing device 800 described with reference to FIG. 8, for example.

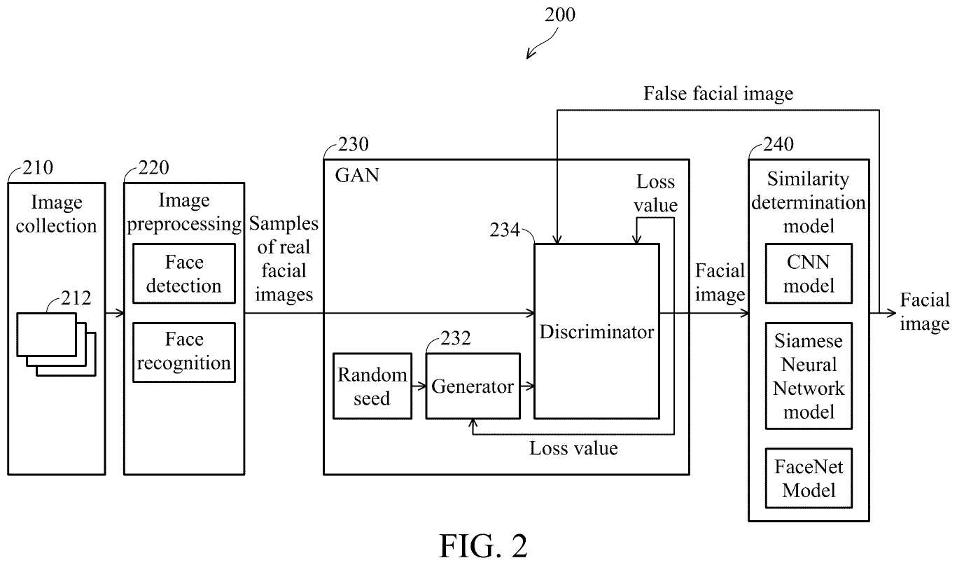

FIG. 2 is a schematic diagram 200 showing a method of generating facial images according to an embodiment of the present disclosure. The method may be executed by the processor 114 of the electronic device 110 in FIG. 1.

As shown in FIG. 2, in the image collection stage 210, the processor may receive a plurality of images 212 generated by a photography device shooting a person at different angles or receive a plurality of images 212 input by a user, wherein the plurality of images 212 are color images.

In the image preprocessing stage 220, the processor performs face detection on the plurality of images 212 and obtains samples of real facial images to establish a character database.

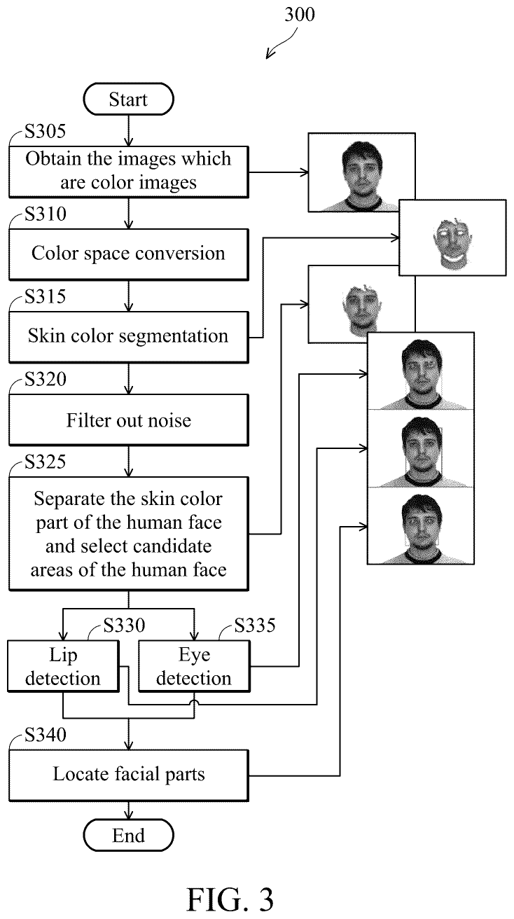

Specifically, FIG. 3 is a schematic diagram 300 illustrating a face detection process according to an embodiment of the present disclosure. As shown in FIG. 3, in step S305, the processor obtains the images 212 which are color images. In step S310, the processor may perform color space conversion on the images 212 through HSV (Hue, Saturation, Value) or YCbCr method. In step S315, the processor performs skin color segmentation on the images 212. Next, in step S320, the processor filters out noise in the images 212. In step S325, the processor separates the skin color part of the human face in the images 212 and selects candidate areas of the human face. In one embodiment, the processor may further utilize the lip detection in step S330 and the eye detection in step S335 to locate facial parts in step S340. The processor may obtain the facial parts in the images 212 as samples of the plurality of real facial images according to the process in FIG. 3.

Alternatively, the processor may use a deep learning model to perform face recognition and mark the recognized facial part as a region of interest (ROI). The processor may use the ROI as a sample of real facial image.

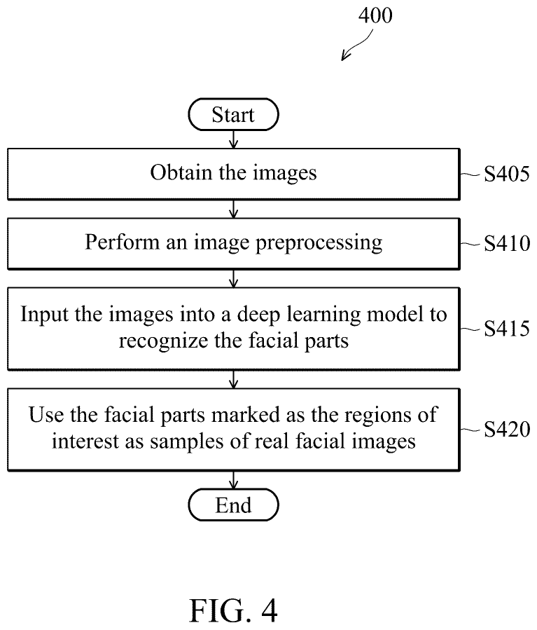

Specifically, FIG. 4 is a schematic diagram 400 illustrating a face recognition process according to an embodiment of the present disclosure. As shown in FIG. 4, in step S405, the processor obtains the images 212. In step S410, the processor performs an image preprocessing on the images. In one embodiment, the image preprocessing includes a grayscale conversion, a size adjustment, a normalized pixel adjustment and other processes. Next, in step S415, the processor inputs the images into a deep learning model to recognize the facial parts, wherein the deep learning model is a convolutional neural network (CNN).

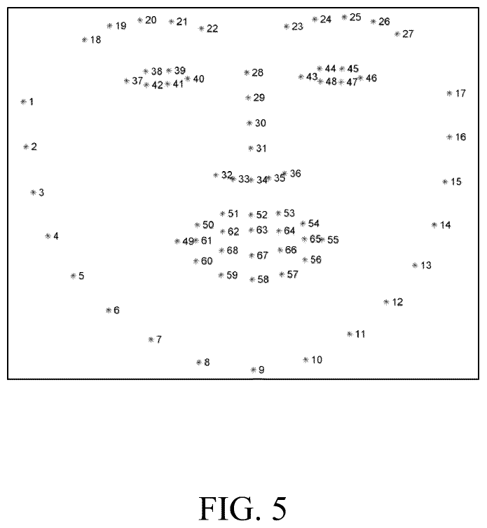

Specifically, the processor may mark different numbers of feature points through a pre-trained deep learning model. As shown in FIG. 5, the deep learning model may mark 68 facial feature points. The deep learning model recognizes facial parts by comparing the images to pre-trained facial feature points. Once the facial parts are found, the deep learning model marks the facial parts as regions of interest. Finally, in step S420, the processor may use the facial parts marked as the regions of interest as samples of real facial images.

In another embodiment, the processor may further classify the facial images using the deep learning model. Specifically, the deep learning model classifies different people after performing the facial recognition, and performs classification based on different facial expression attributes to build a character database. For example, the deep learning model may classify facial expressions based on the smiling face of character A, the crying face of character A, the smiling face of character B, and the eye-closing movement of character B.

Returning to FIG. 2, the processor then inputs the samples of real facial images into a Generative Adversarial Network (GAN) 230, wherein the GAN 230 is composed of a generator 232 and a discriminator 234.

The generator 232 generates a facial image according to a random seed and inputs the facial image to the discriminator 234. The discriminator 234 receives the samples of real facial images and the facial image generated by the generator 232 and determines whether the facial image is a real facial image.

When the discriminator 234 determines that the facial image is not a real facial image, the discriminator 234 generates a loss value and feeds back the loss value to the discriminator 234 and the generator 232. Specifically, the loss value may include a generator loss and a discriminator loss. When the generator loss is lower, the facial image generated by the generator is closer to the real facial image. When the discriminator loss is lower, the accuracy of the discriminator in distinguishing between the real facial image and the facial image generated by the generator is higher. When the discriminator determines that the facial image generated by the generator is a real facial image, the GAN 230 may generate a facial image that is close to the samples of real facial images.

Next, the processor inputs the facial image generated by the GAN 230 to at least one similarity determination model 240. The similarity determination models 240 may infer a similarity score for the facial image. Three similarity determination models are introduced below for explanation.

### Convolutional Neural Network (CNN) Model

The structure of the CNN model is composed of multiple layers, including a convolution layer, a pooling layer and a fully connected layer. The CNN model processes facial images through a series of transformations.

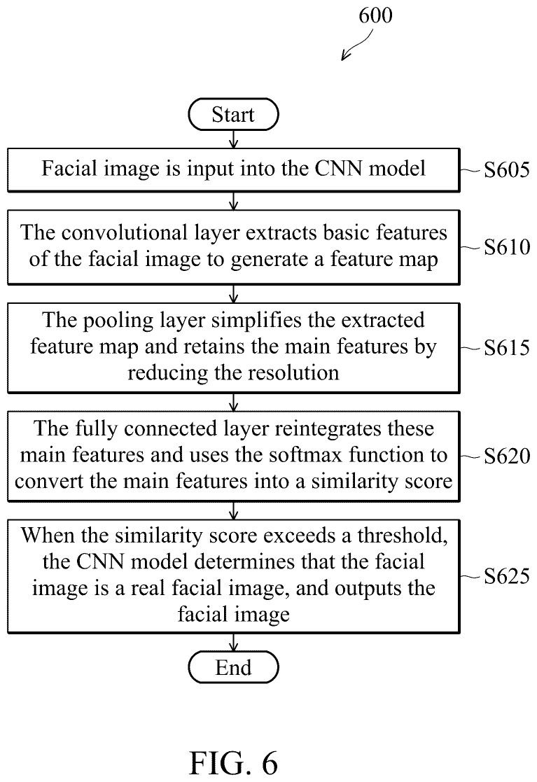

FIG. 6 is a flowchart 600 for inferring a similarity score for a facial image using a convolutional neural network model according to an embodiment of the present disclosure.

In step 605, the facial image is input into the CNN model. In step S610, the convolutional layer extracts basic features of the facial image to generate a feature map. Next, in step S615, the pooling layer simplifies the extracted feature map and retains the main features by reducing the resolution. The pooling layer effectively reduce the size and computational requirements of facial image. In step S620, the fully connected layer reintegrates these main features and uses the softmax function to convert the main features into a similarity score, wherein the similarity score is a probability value. In step S625, when the similarity score exceeds a threshold, the CNN model determines that the facial image is a real facial image, and outputs the facial image.

In step S620, the CNN model uses the softmax function to calculate a probability distribution, and selects the face with the highest probability value as the similarity score for the facial image, wherein the sum of the probability values combining the probability distribution is 1. For example, the CNN model considers that the probability value that the facial image belongs to person A is 0.6, and the probability value that the facial image belongs to person B is 0.4. Therefore, the CNN model determines that the facial image is similar to person A.

### Siamese Neural Network Model

Siamese neural network is a technology used for face recognition. The Siamese neural network model uses two neural networks to compare the similarity between the facial image generated by the GAN and the real facial image, and determine whether the two facial images belong to the same person. The Siamese neural network model extracts features for each facial image and measures the similarities between these features.

Specifically, the processor may input two facial images to be compared into a first neural network and a second neural network respectively. The first neural network and the second neural network may share the same parameters and weights, and have the same architecture. For example, the first neural network and the second neural network include a convolution layer and a pooling layer, wherein the convolution layer and the pooling layer are used to extract the features of the facial images to calculate the similarity between two facial images.

The Siamese neural network model uses the Euclidean distance or the cosine similarity to determine whether two facial images are similar.

The cosine similarity cos(θ) can be expressed by the following formula:

$$cos ( θ ) = A \cdot B / ( ‖ A ‖ * ‖ B ‖ )$$

wherein A is a vector of the first facial image, B is a vector of the second facial image, θ is the angle between the two vectors, A·B is the dot product of the vectors, ∥A∥ is the length of the vector of the first facial image, ∥B∥ is the length of the vector of the second facial image.

Euclidean distance is a method used to measure the distance between two points in two-dimensional space. In the Siamese neural network, the pixels or coordinate values of the facial images are not directly compared, but the high-dimensional feature vector of each facial image is extracted.

For example, the Siamese neural network model first extracts each feature vector v1₁, v1₂, . . . , v1ₙ of the first facial image A and each feature vector v2₁, v2₂, . . . , v2ₙ of the second facial image B. The first facial image A and the second facial image B are represented by the following formulas:

$$A = ( \begin{matrix}v {1}_{1} \\ v {1}_{2} \\ . \\ . \\ . \\ v {1}_{n}\end{matrix} )$$

$$B = ( \begin{matrix}v {2}_{1} \\ v {2}_{2} \\ . \\ . \\ . \\ v {2}_{n}\end{matrix} )$$

wherein the feature vector v1₁, v1₂, . . . , v1ₙ of the first facial image A respectively correspond to the feature vector v2₁, v2₂, . . . , v2ₙ of the second facial image B at the same position.

Then, the Euclidean distance dis used to measure the distance between the high-dimensional feature vectors, and the formula is as follows:

$$d = \sqrt{{( v {1}_{1} - v {2}_{1} )}^{2} + {( v {1}_{2} - v {2}_{2} )}^{2} + ⋯ + {( v {1}_{n} - v {2}_{n} )}^{2}}$$

The value range of Euclidean distance d is non-negative real numbers. The smaller the value of the Euclidean distance d, the closer the two feature vectors are, that is, the more similar the two facial images are. The larger the value of the Euclidean distance d, the farther away the two feature vectors are, that is, the less similar the two facial images are.

Next, the Siamese neural network model performs L2 normalization on cosine similarity and Euclidean distance. The value range of the Euclidean distance after L2 normalization is between 0 and 2. The smaller the Euclidean distance, the more similar the two facial images are. The value range of the cosine similarity after L2 normalization is between 0 and 1. The smaller the value, the lower the similarity between the two facial images. The larger the value, the higher the similarity between the two facial images.

### FaceNet Model

The goal of the FaceNet model is to train a high-dimensional transformation space so that the feature distance after mapping of facial images including the same face is as small as possible, and the feature distance after face mapping of facial images including different people is as far away as possible. The FaceNet model uses triplet loss as the loss function. The concept of the loss function is to extract three feature vectors from each sample of facial image: Anchor (target face), Positive (face of the same person as Anchor), Negative (face of a person different from Anchor). In this way, the FaceNet model may learn how to better distinguish the features of different faces.

The training data set is divided into multiple batches, and each batch usually contains about 40 facial images. At the same time, the FaceNet model also needs to randomly sample Negative and add new samples to each batch to ensure that the FaceNet model may fully learn facial features during the learning process. The Facenet model is usually trained with L2 normalization function and loss function. The L2 normalization function is used to control the complexity of the Facenet model, and the embeddings of the image only need to be represented by 128-dimensional feature vectors to maintain the accuracy of facial recognition.

Finally, the Facenet model evaluates the number of elements in the TA (True Accepts) and FA (False Accepts) sets, and calculates the probability of correctly determining that the facial images belong to the same person when the facial images belong to the same person, and the probability of being misjudged as belonging to the same person when the facial images belong to different people, wherein TA represents the facial images that belong to the same person in paired facial images, and FA represents the facial images that do not belong to the same person in paired facial images.

In the embodiment, the Facenet model may set a TA threshold and a FA threshold for TA and FA, respectively. When the similarity score is greater than the TA threshold, the Facenet model determines that the paired facial images belong to the same person. Otherwise, the Facenet model determines that the paired facial images do not belong to the same person. When the similarity score is greater than the FA threshold, the Facenet model determines that the paired facial images do not belong to the same person. Otherwise, the Facenet model determines that the paired facial images belong to the same person.

For example, it is assumed that the TA threshold is 0.5 and the FA threshold is 0.1. The Facenet model calculates TA as 0.9 and is greater than the TA threshold that is 0.5. In other words, when the facial images belong to the same person, the probability that the Facenet model correctly determines that the facial images belong to the same person is 90%. The Facenet model calculates FA as 0.05 and less than the FA threshold that is 0.1. In other words, when the facial images belong to different people, the probability that the Facenet model misjudges that the facial images belong to the same person is 5%.

It should be noted that although the similarity determination model 240 uses the CNN model, the Siamese neural network model, and the Facenet model as examples in FIG. 2, it should not be limited in the disclosure.

Returning to FIG. 2, when the similarity score for the facial image exceeds a threshold, the similarity determination model 240 determines that the facial image is a real facial image and outputs the facial image. When the similarity score for the facial image does not exceed the threshold, the similarity determination model 240 marks the facial image as a false facial image, and feeds the false facial image back to the discriminator 234. The discriminator 234 may check again whether the facial image generated by the generator 242 is similar to the previous false facial image. When the discriminator 234 determines that the facial image generated by the generator 242 is similar to the previous false facial image, the discriminator 234 generates a loss value and feeds the loss value back to the discriminator 234 and the generator 222. The generator 222 may regenerate the facial image according to the loss value, so that the regenerated facial image is closer to the real facial image.

In one embodiment, to avoid spending too much time or generating times in the process of generating a facial image, the processor may use a condition as a judgment for adjusting the threshold. For example, when the similarity scores inferred by the similarity determination model within a preset time period do not exceed the threshold and are within a preset range, the similarity determination model may lower the threshold to speed up the generation of facial images. To give another example, when the number of times that the similarity determination model infers similarity scores exceeds a preset number, the similarity determination model may lower the threshold to speed up the generation of facial images.

In an embodiment, when the number of similarity determination models is more than three and an odd number, the processor may determine whether to output a facial image according to the following conditions. When more than half of the similarity determination models determine that the facial image is a real facial image, the processor outputs the facial image. When more than half of the similarity determination models determine that the facial image is not a real facial image, the similarity determination model marks the facial image as a false facial image and feeds the false facial image back to the discriminator 234. For example, it is assumed that there are five similarity determination models. When three similarity determination models determine that the facial image is a real facial image, the processor outputs the facial image. When three similarity determination models determine that the facial image is not a real facial image, the similarity determination model marks the facial image as a false facial image and feeds the false facial image back to the discriminator.

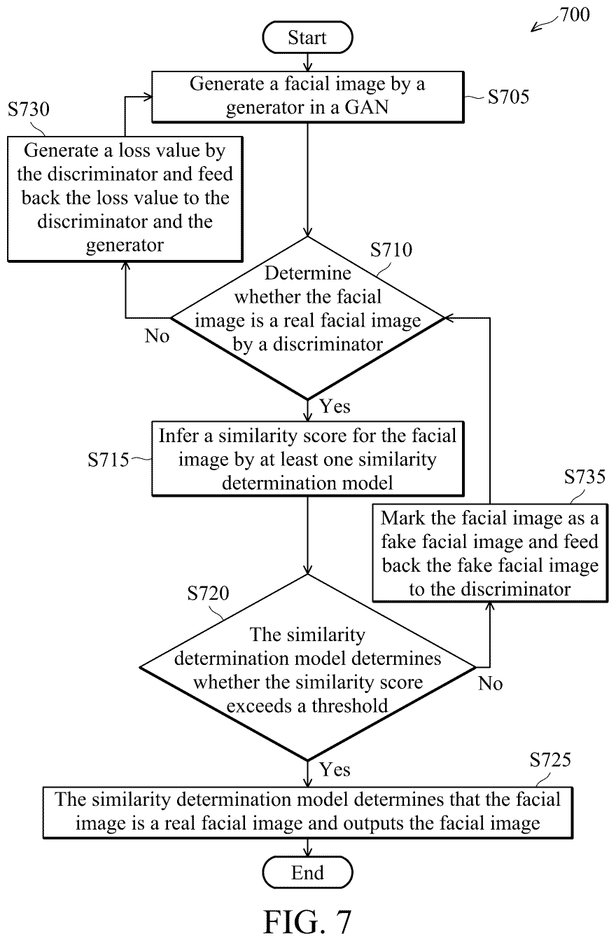

FIG. 7 is a flowchart illustrating a method 700 for generating facial images according to an embodiment of the present disclosure. This method may be executed by an electronic device, and the electronic device may be implemented by the processor 114 in the electronic device 110 of the system 100 for generating facial images shown in FIG. 1.

In step S705, the processor generates a facial image by a generator in a generative adversarial network (GAN).

In step S710, the processor determines whether the facial image is a real facial image by a discriminator in the GAN.

When the discriminator determines that the facial image is a real facial image (“Yes” in step S710), in step S715, the processor infers a similarity score for the facial image by at least one similarity determination model.

In step S720, the similarity determination model determines whether the similarity score exceeds a threshold. In one embodiment, the similarity determination model is based on a convolutional neural network (CNN) model, and the similarity score is a probability value. In another embodiment, the similarity determination model is based on a Siamese neural network model, and the similarity score is a cosine similarity or a Euclidean distance. In another embodiment, the similarity determination model is based on a Facenet model, and the similarity score is a probability value.

When the similarity score exceeds a threshold (“Yes” in step S720), in step S725, the similarity determination model determines that the facial image is a real facial image and outputs the facial image.

The method returns to step S710, when the discriminator determines that the facial image is not a real facial image (“No” in step S710), in step S730, the processor generates a loss value by the discriminator and feeds back the loss value to the discriminator and the generator. After receiving the loss value, the generator may generate a new facial image based on the loss value and the random seed.

The method returns to S720, when the similarity score does not exceed a threshold (“No” in step S720), in step S735, the processor marks the facial image as a fake facial image and feeds back the fake facial image to the discriminator by the similarity determination model. The discriminator then checks whether the facial image generated by the generator is similar to the previous fake facial image. In one embodiment, when the similarity score does not exceed the threshold and a condition is met, the processor may adjust the threshold. The condition is one of the following: the similarity scores inferred by the similarity determination model within a preset time period do not exceed the threshold and are within a preset range; and the number of times the similarity determination model has inferred the similarity scores have exceeded a preset number.

In one embodiment, before the process of FIG. 7, the processor may receive a plurality of images of a person captured by a photographing device and obtain the facial part in the images as samples a plurality of real facial images. The processor inputs the samples of the real facial images to the discriminator. The discriminator receives the samples of the real facial images and the facial image generated by the generator and determines whether the facial image is a real facial image.

In an embodiment, when the number of similarity determination models is more than three and an odd number, the processor may further perform the following steps. When more than half of the similarity determination models determine that the facial image is a real facial image, the similarity determination model outputs the facial image. When more than half of the similarity determination models determine that the facial image is not a real facial image, the similarity determination model marks the facial image as a false facial image and feeds back the false facial image to the discriminator.

In one embodiment, the GAN and the similarity determination model are executed by a graphics processing unit (GPU). Compared with the CPU, the GPU has a large amount of computing cores, so the GPU is suitable for simultaneous computing and processing of non-dependent data, which can effectively shorten the overall computing time when using the CPU.

As mentioned above, the method and device for generating facial images provided in this disclosure use a generative adversarial network to generate a facial image and use a similarity determination model to further determine the similarity of the facial image, so as to achieve the purpose of generating facial images that are more natural and similar to real facial expressions.

Having described embodiments of the present disclosure, an exemplary operating environment in which embodiments of the present disclosure may be implemented is described below. Referring to FIG. 8, an exemplary operating environment for implementing embodiments of the present disclosure is shown and generally known as a computing device 800. The computing device 800 is merely an example of a suitable computing environment and is not intended to limit the scope of use or functionality of the disclosure. Neither should the computing device 800 be interpreted as having any dependency or requirement relating to any one or combination of components illustrated.

The disclosure may be realized by means of the computer code or machine-useable instructions, including computer-executable instructions such as program modules, being executed by a computer or other machine, such as a personal data assistant (PDA) or other handheld device. Generally, program modules may include routines, programs, objects, components, data structures, etc., and refer to code that performs particular tasks or implements particular abstract data types. The disclosure may be implemented in a variety of system configurations, including hand-held devices, consumer electronics, general-purpose computers, more specialty computing devices, etc. The disclosure may also be implemented in distributed computing environments where tasks are performed by remote-processing devices that are linked by a communication network.

With reference to FIG. 8, the computing device 800 may include a bus 810 that is directly or indirectly coupled to the following devices: one or more memories 812, one or more processors 814, one or more display components 816, one or more input/output (I/O) ports 818, one or more input/output components 820, and an illustrative power supply 822. The bus 810 may represent one or more kinds of busses (such as an address bus, data bus, or any combination thereof). Although the various blocks of FIG. 8 are shown with lines for the sake of clarity, and in reality, the boundaries of the various components are not specific. For example, the display component such as a display device may be considered an I/O component and the processor may include a memory.

The computing device 800 typically includes a variety of computer-readable media. The computer-readable media can be any available media that can be accessed by computing device 800 and includes both volatile and nonvolatile media, removable and non-removable media. By way of example, not limitation, computer-readable media may comprise computer storage media and communication media. The computer storage media may include volatile and nonvolatile, removable and non-removable media implemented in any method or technology for storage of information such as computer-readable instructions, data structures, program modules or other data. The computer storage media may include, but not limit to, random access memory (RAM), read-only memory (ROM), electrically-erasable programmable read-only memory (EEPROM), flash memory or other memory technology, compact disc read-only memory (CD-ROM), digital versatile disks (DVD) or other optical disk storage, magnetic cassettes, magnetic tape, magnetic disk storage or other magnetic storage devices, or any other medium which can be used to store the desired information and which can be accessed by the computing device 800. The computer storage media may not comprise signals per se.

The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, but not limitation, communication media includes wired media such as a wired network or direct-wired connection, and wireless media such as acoustic, RF, infrared and other wireless media or any combination thereof.

The memory 812 may include computer-storage media in the form of volatile and/or nonvolatile memory. The memory may be removable, non-removable, or a combination thereof. Exemplary hardware devices include solid-state memory, hard drives, optical-disc drives, etc. The computing device 800 includes one or more processors that read data from various entities such as the memory 812 or the I/O components 820. The display component(s) 816 present data indications to a user or to another device. Exemplary presentation components include a display device, speaker, printing component, vibrating component, etc.

The I/O ports 818 allow the electronic device 800 to be logically coupled to other devices including the I/O components 820, some of which may be embedded. Illustrative components include a microphone, joystick, game pad, satellite dish, scanner, printer, wireless device, etc. The I/O components 820 may provide a natural user interface (NUI) that processes gestures, voice, or other physiological inputs generated by a user. For example, inputs may be transmitted to an appropriate network element for further processing. The computing device 800 may be equipped with depth cameras, such as stereoscopic camera systems, infrared camera systems, RGB camera systems, or any combination thereof, to detect and identify objects. In addition, the computing device 800 may be equipped with sensors (e.g., radar, lidar) to periodically sense the surrounding environment within a sensing range and generate sensor information representing the relationship between the computing device 800 and the surrounding environment. Furthermore, the computing device 800 may be equipped with accelerometers or gyroscopes that enable detection of motion. The output of the accelerometers or gyroscopes may be provided to the computing device 800 for display.

Furthermore, the processor 814 in the computing device 800 can execute the program code in the memory 812 to perform the above-described actions and steps or other descriptions herein.

It should be understood that any specific order or hierarchy of steps in any disclosed process is an example of a sample approach. Based upon design preferences, it should be understood that the specific order or hierarchy of steps in the processes may be rearranged while remaining within the scope of the present disclosure. The accompanying method claims present elements of the various steps in a sample order, and are not meant to be limited to the specific order or hierarchy presented.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the disclosure has been described by way of example and in terms of the preferred embodiments, it should be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for generating facial images, used in a device, comprising:
generating, by a generator of a generative adversarial network (GAN), a facial image;
determining, by a discriminator of the GAN, whether the facial image is a real facial image;
inferring, by at least one similarity determination model, a similarity score for the facial image when the discriminator determines that the facial image is the real facial image; and
determining that the facial image is the real facial image and outputting the facial image when the similarity score exceeds a threshold.

2. The method for generating facial images as claimed in claim 1, further comprising:
generating, by the discriminator, a loss value and feeding back the loss value to the discriminator and the generator when the discriminator determines that the facial image is not the real facial image.

3. The method for generating facial images as claimed in claim 1, further comprising:
marking, by the similarity determination model, the facial image as a false facial image, and feeding the false facial image back to the discriminator when the similarity score does not exceed the threshold.

4. The method for generating facial images as claimed in claim 1, wherein before the generator generates the facial image, the method further comprises:
receiving a plurality of images of a person captured by a photographic device; and
obtaining, by a processor, the facial part in the plurality of images as samples of a plurality of real facial images.

5. The method for generating facial images as claimed in claim 1, further comprising:
adjusting the threshold when the similarity score does not exceed the threshold and a condition is met;
wherein the condition is one of the following:
the similarity scores inferred by the similarity determination model within a preset time period do not exceed the threshold and are within a preset range; and
a number of times the similarity determination model has inferred the similarity scores have exceeded a preset number.

6. The method for generating facial images as claimed in claim 1, wherein when a number of similarity determination models is more than three and an odd number, the method further comprises:
outputting the facial image when more than half of the similarity determination models determine that the facial image is the real facial image; and
marking the facial image as a false facial image and feeding the false facial image back to the discriminator when more than half of the similarity determination models determine that the facial image is not the real facial image.

7. The method for generating facial images as claimed in claim 1, wherein the similarity determination model is based on a convolutional neural network (CNN) model, and the similarity score is a probability value.

8. The method for generating facial images as claimed in claim 1, wherein the similarity determination model is based on a Siamese neural network model, and the similarity score is a cosine similarity or a Euclidean distance.

9. The method for generating facial images as claimed in claim 1, wherein the similarity determination model is based on a Facenet model, and the similarity score is a probability value.

10. The method for generating facial images as claimed in claim 1, wherein the GAN and the similarity determination model are executed by a graphics processing unit (GPU).

11. A device for generating facial images, comprising:
one or more processors; and
one or more computer storage media for storing one or more computer-readable instructions, wherein the processor is configured to drive the computer storage media to execute the following tasks:
generating a facial image by a generator of a generative adversarial network (GAN);
determining whether the facial image is a real facial image by a discriminator of the GAN;
inferring a similarity score for the facial image by at least one similarity determination model when the discriminator determines that the facial image is the real facial image; and
determining that the facial image is the real facial image and outputting the facial image when the similarity score exceeds a threshold.

12. The device for generating facial images as claimed in claim 11, wherein the processor further executes the following tasks:
generating a loss value and feeding back the loss value to the discriminator and the generator by the discriminator when the discriminator determines that the facial image is not the real facial image.

13. The device for generating facial images as claimed in claim 11, wherein the processor further executes the following tasks:
marking the facial image as a false facial image and feeding the false facial image back to the discriminator by the similarity determination model when the similarity score does not exceed the threshold.

14. The device for generating facial images as claimed in claim 11, wherein before the generator generates the facial image, the processor further executes the following tasks:
receiving a plurality of images of a person captured by a photographic device; and
obtaining the facial part in the plurality of images as samples of a plurality of real facial images.

15. The device for generating facial images as claimed in claim 11, wherein the processor further executes the following tasks:
adjusting the threshold when the similarity score does not exceed the threshold and a condition is met;
wherein the condition is one of the following:
the similarity scores inferred by the similarity determination model within a preset time period do not exceed the threshold and are within a preset range; and
the number of times the similarity determination model has inferred the similarity scores have exceeded a preset number.

16. The device for generating facial images as claimed in claim 11, wherein when the number of similarity determination models is more than three and an odd number, the processor further executes the following tasks:
outputting the facial image when more than half of the similarity determination models determine that the facial image is the real facial image; and
marking the facial image as a false facial image and feeding the false facial image back to the discriminator when more than half of the similarity determination models determine that the facial image is not the real facial image.

17. The device for generating facial images as claimed in claim 11, wherein the similarity determination model is based on a convolutional neural network (CNN) model, and the similarity score is a probability value.

18. The device for generating facial images as claimed in claim 11, wherein the similarity determination model is based on a Siamese neural network model, and the similarity score is a cosine similarity or a Euclidean distance.

19. The device for generating facial images as claimed in claim 11, wherein the similarity determination model is based on a Facenet model, and the similarity score is a probability value.

20. The device for generating facial images as claimed in claim 11, wherein the GAN and the similarity determination model are executed by a graphics processing unit (GPU).
